(19) United States
(12) Patent Application Publication
(10) Pub. No.: US 2003/0008650 A1
(43) Pub. Date: Jan. 9, 2003

(54) Remote control of downloading of content data by mobile device from one server to another

(75) Inventors: Yoshihiro Matsuyama, Kawasaki (JP); Isamu Yamada, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/981,982

(22) Filed: Oct. 19, 2001

(30) Foreign Application Priority Data
Jul. 9, 2001 (JP) 2001-207448

(51) Int. Cl. H04Q 7/20

(52) U.S. Cl. 455/426; 455/556

(57) ABSTRACT

A content data distributing system includes a first information processing apparatus connected to a first network having a mobile communication function, and a second information processing connected to a second network which, in turn, is connected to said first network. The first information processing apparatus receives, over the first network, a content identification of a content determined by a user and an address of a third information processing apparatus determined by the user which is to receive data of the content, and transmits the received content identification and third information processing apparatus address to the second information processing apparatus over the first and second networks. The second information processing apparatus receives the content identification and the address of the third information processing apparatus and transmits content data associated with the content identification received to the third information processing apparatus over the second network.

### FIELD OF THE INVENTION

This invention relates to controlling of downloading by an information processing device of a content from one web server to another information processing device, and, more particularly, to controlling by a mobile device of downloading of a content from a web server to another information processing device over a network.

### BACKGROUND OF THE INVENTION

It is possible for a user of a mobile telephone to connect the telephone to the Internet over a mobile communication network to thereby capture and display on the mobile telephone a content stored in a server connected to the Internet. However, due to limited bandwidths of the mobile communication network, the transmission rate is 9.6 Kbps for a cellular phone and 64 Kbps for a PHS. Such transmission rate may be insufficient to receive content data, such as high-quality motion pictures or music, and, therefore, a long time and a high mobile communication fee will be required to receive such content data.

Recently, high-speed subscriber communication lines which are connected perpetually to a network like the Internet have become commercially available to general users of information processing devices such as home personal computers, which has made it possible for servers to provide video and audio data streams containing contents, such as high-quality motion pictures and music. Some contents may be supplied only during a limited time period.

Users are not always beside their information processing devices. Besides, when a user is away from his or her information processing device, he or she cannot download a desired content into the information processing device.

T. Hamamoto discloses in Japanese Application Publication No. 2000-207326 A laid open for public inspection on Jul. 28, 2000, a technique in which data for a personal information manager (PIM) is stored in a gateway server, which, in response to an access by a mobile terminal device or stationary terminal device, checks the PIM data and takes required information from a web server connected to the Internet to send it to the terminal. The gateway server determines required information based on the PIM data and supplies it to the mobile or stationary terminal. However, the user cannot designate the information content or a receiver to which the information is to be sent.

A. Hatakeyama in his Japanese Patent Application Publication No. HEI 08-293827 A laid open for public inspection on Nov. 5, 1996, discloses multiplexing news information and advertisement information and distributing the multiplexed information via a satellite to receiving stations. The receiving stations store only information that users require. The receiving stations can reproduce information in any format. The information to be received is selected in accordance with predetermined conditions. However, in this system, the users cannot designate the information content or the receivers to which the information content is to be sent.

An object of the present invention is to make it possible for a user in any mobile environment to download content data from a server to a particular information processing device.

Another object of the present invention is to make it possible to download data of different contents into one information processing device to manage the data.

A still other object of the present invention is to make it possible to download a large amount of content data over a high speed and inexpensive network.

### SUMMARY OF THE INVENTION

In accordance with an aspect of the present invention, a mobile device is provided with a processor, a memory device, an input device and a display device. The processor transmits a content transmission request including an identification of a content designated by a user and an address of a device designated by the user which is to receive data of the designated content, to an information processing apparatus over a mobile communication network. The data receiving device is different from the mobile device.

In accordance with another aspect of the invention, an information processing apparatus includes a processor and a memory device. The processor of the apparatus receives a content transmission request including an identification of a content designated by a user and an address of a device designated by the user which is to receive data of the designated content, from another device different from the data receiving device over a mobile communication network. The processor transmits, over a network, the received content identification and receiving device address to another information processing apparatus which provides the content data.

In accordance with a further aspect of the invention, an information processing apparatus includes a processor and a memory device. The processor receives a content transmission request including an identification of a content designated by a user and an address of a device designated by the user which is to receive data of the designated content, from another apparatus different from the data receiving device over a network. The processor provides and transmits content data associated with the content identification to the data receiving device.

In accordance with a still further aspect of the invention, an information processing apparatus includes a processor and a memory device. The processor receives a content transmission request including an identification of a content designated by a user and an address of a device designated by the user which is to receive data of the designated content, from another device different from the data receiving device over a mobile communication network. The processor transmits a content capturing or downloading request including the content identification to the receiving device over a network.

In accordance with a still further aspect of the present invention, an information processing apparatus includes a processor and a memory device. The processor receives, from another apparatus over a network, a content capturing request including an identification of content designated by a user. Using the content identification, the processor accesses a different information processing apparatus providing content data over the network to receive the content data associated with the content identification from the different information processing apparatus.

A program for use in a mobile device is operable to cause a processor of the mobile device to execute the step of transmitting, over a mobile network to an information processing apparatus, a content transmission request including an identification of a content designated by a user and an address of a device designated by the user which is to receive data of the designated content. The data receiving device is different from the mobile device.

A program for use in an information processing apparatus is operable to cause the information processing apparatus to execute the step of receiving a content transmission request including an identification of a content designated by a user and an address of a device designated by the user which is to receive data of the designated content, from a device different from the data receiving device over a mobile network, and the step of transmitting the received content identification and receiving device address to a content data providing information processing apparatus over a network.

A program for use in an information processing apparatus is operable to cause the apparatus to execute the step of receiving a content transmission request including an identification of a content designated by a user and an address of a device designated by the user which is to receive data of the designated content, from another apparatus different from the data receiving device over a network, and the step of providing and transmitting content data associated with the content identification to the data receiving device.

A program for use in an information processing apparatus is operable to cause the apparatus to execute the step of receiving a content transmission request including an identification of a content designated by a user and an address of a device designated by the user which is to receive data of the designated content, from another device different from the data receiving device over a mobile communication network, and the step of transmitting a content capturing or downloading request including the content identification to the data receiving device over a network.

A program for use in an information processing apparatus is operable to cause the apparatus to execute the step of receiving a content capturing or downloading request including an identification of content determined by a user from another apparatus over a network, and the step of accessing, using the content identification, a content data providing information processing apparatus over the network to receive content data associated with the content identification from the content data providing information processing apparatus.

According to the present invention, a user in a mobile environment can download content data from a server to a particular information processing device, can download and manage data of different contents into one information processing device, and can download a large amount of content data over an high-speed and inexpensive network.

### BRIEF DESCRIPTION OF THE DRAWINGS

FIG. 1 shows a configuration of a system according to an embodiment of the present invention and an arrangement of a mobile telephone in the system;

FIG. 2 shows an arrangement of each of information, accounting and content servers;

FIG. 3 shows an arrangement of a home server;

FIGS. 4A through 4C show a flow chart of steps executed over a network, a mobile communication network and a gateway, by a mobile telephone, an information server, an accounting server, a content server and a home server like the ones shown in FIGS. 1-3, according to one embodiment of the present invention; and

FIGS. 5A through 5C shows a flow chart of steps, according to another embodiment of the present invention, which are executed over a network, a mobile communication network and a gateway, by a mobile telephone, an information server, an accounting server, a content server and a home server like the ones shown in FIGS. 1-3.

### DESCRIPTION OF PREFERRED EMBODIMENTS

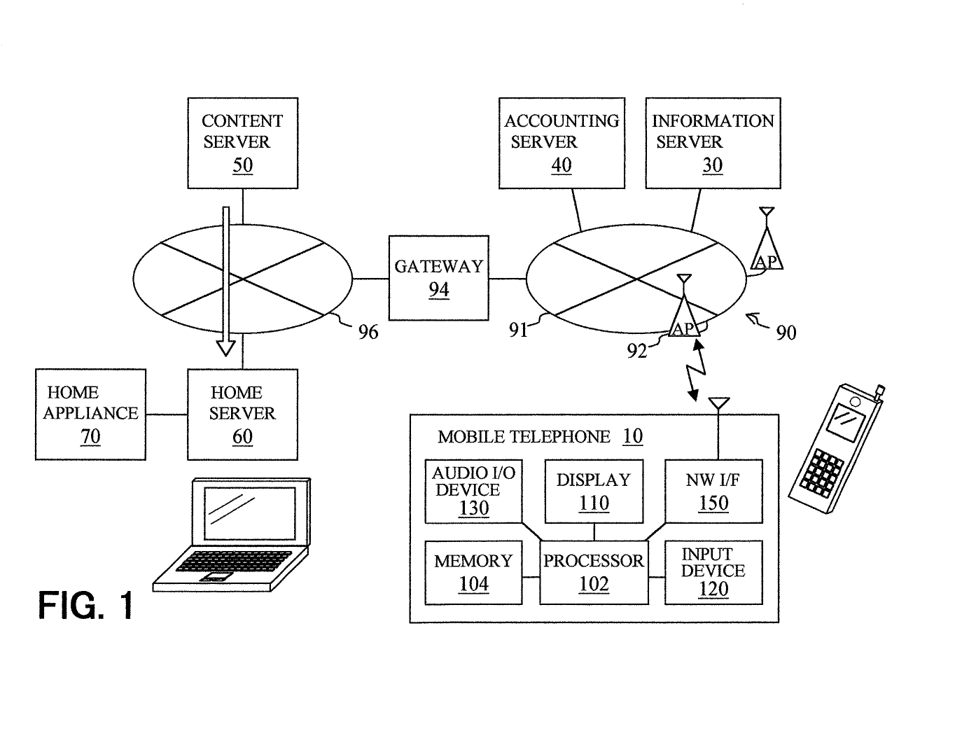

FIG. 1 shows a configuration of a content data distributing system according to one embodiment of the present invention, and an arrangement of a mobile telephone 10 forming part of the system. In FIG. 1, the mobile telephone 10 is connected to an information server 30 and an accounting server 40 over a mobile communication network 90 including a network 91 and a plurality of mobile wireless communication access points 92 connected to the network 91. The network 91 may be, for example, the PSTN or the ISDN. A content server 50 and a home server 60 are connected to each other over a high speed network 96, e.g. the Internet. The network 91 in the mobile communication network 90 is connected through a gateway 94 to the high speed network 96. The home server 60 is connected to a home electric appliance 70 of the user, such as a television set or an audio device. The information server 30 and the accounting server 40 may be integrated into one server.

The mobile telephone 10 includes a processor 102, a memory device 104, a display device 110, an input device 120, an audio input/output device 130 including a microphone, a loudspeaker and an audio circuit, and a network interface (NW I/F) 150 including a transceiver to communicate with the access point 92 on the mobile communication network 90. The memory device 104 has stored therein applications to be executed by the processor 102 including a browser application and an application for downloading content data to a device having an address designated by the user.

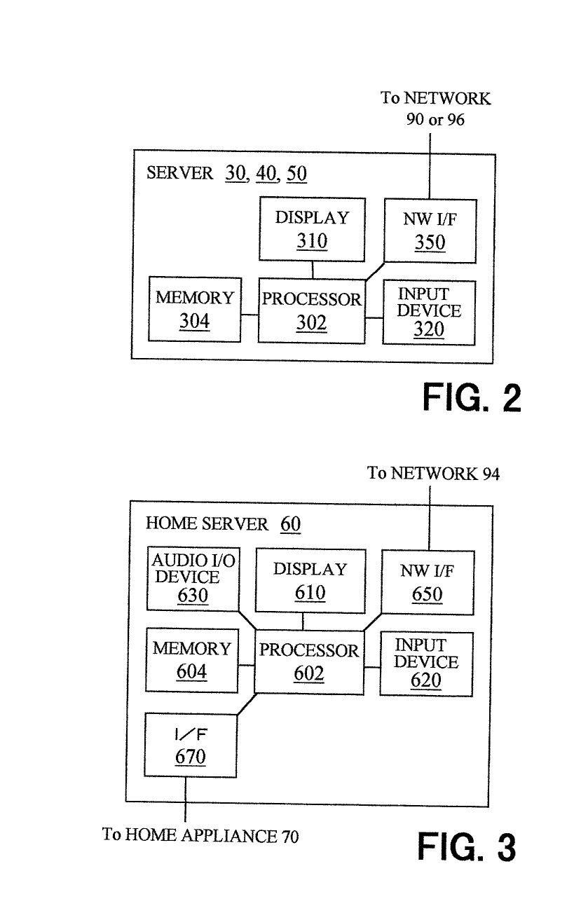

FIG. 2 shows an arrangement of each of the information server 30, the accounting server 40 and the content server 50. Each of the information server 30, the accounting server 40 and the content server 50 includes a processor 302, a memory device 304, such as a magnetic disc, a RAM and a ROM, a display device 310, an input device 320, such as a keyboard, and a network interface 350 connected to the corresponding one of the networks 91 and 96. The servers 30, 40 and 50 transmit and receive data to and from each other for providing required services to the mobile telephone 10 and the home server 60. The memory device 304 has stored therein an application executed by the processor 302 for downloading content data to a device having an address designated by the user, and the like.

FIG. 3 shows an arrangement of the home server 60. The home server 60 may be a typical personal computer. The home server 60 includes a processor 602, a memory device 604, such as a magnetic disc, a RAM and a ROM, a display device 610, an input device 620, such as a keyboard and a mouse, an audio input/output device 630 including a microphone, a loudspeaker and an audio circuit, a network interface 650 connected to the network 96, and an appliance network interface 670 with the home appliance 70. The home server 60 is perpetually in connection with the network 96 through the network interface 650. The memory device 604 has stored therein an application to be executed by the processor 602 for downloading content data designated by the user into the memory device 604.

The content server 50 provides detailed or high-quality content data to an information processing device, e.g. the home server PC 60 or other client PCs, connected to the network 96. The content data herein may include contents such as high-quality video and/or audio data streams and document data, and application programs, all of which are periodically changed or updated. Such contents and programs may include different news video clips updated periodically, e.g. at intervals of two hours, a plurality of periodically changed video and/or audio programs distributable upon request by users, periodically updated weather information of the weather in particular areas, and different periodically added, changed or deleted document data and application programs.

The information server 30 provides, in response to an access thereto by the mobile telephone 10, a Web page containing a receivable and displayable amount of data, i.e. data in such an amount that the mobile telephone 10 can receive and display, to the mobile telephone 10. The Web page contains information relating to the above-mentioned plurality of contents the content server 50 can provide in respective ones of time intervals, and identifications (IDs) of the contents, and the fees for making use of the respective contents. The identification may be the titles or names and/or URLs of the respective contents. The Web page may contain, for example, a news summary including summaries of the above-mentioned news clips updated at two-hour intervals and their IDs, a program guide including information relating to the above-mentioned video and/or audio programs and their respective IDs, weather information including briefs of the above-mentioned weather in particular areas and their respective IDs, and advertisements including information about the above-mentioned documents and application programs and their respective IDs.

The accounting server 40 manages the user accounts relating to telephone charges of the mobile telephone 10 and the fees for the services provided for the mobile telephone 10.

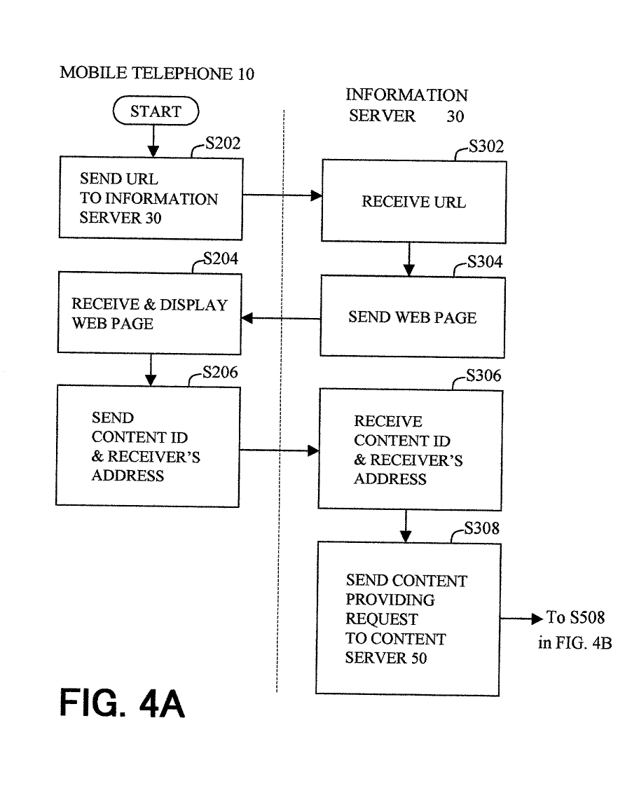

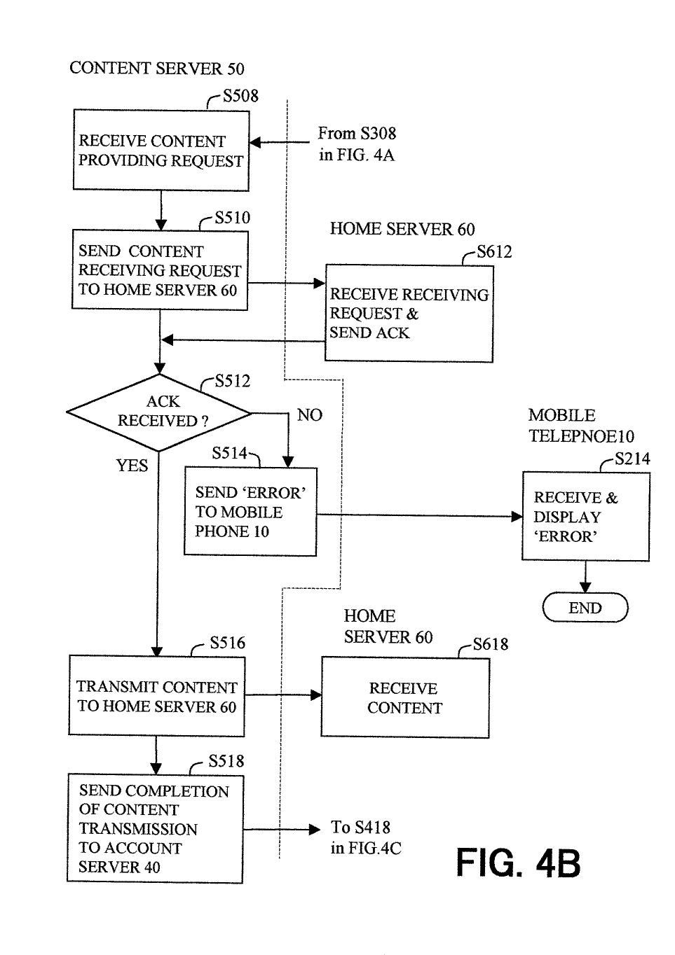

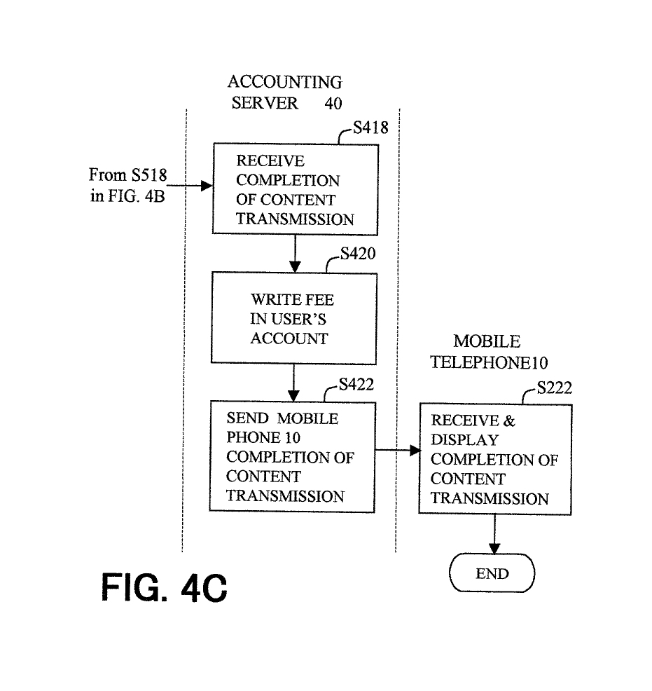

FIGS. 4A through 4C together show an exemplary flow chart of the program executed by the mobile telephone 10, the information server 30, the accounting server 40, the content server 50 and the home server 60, through the mobile communication network 90, the network 96 and the gateway 94.

At Step 202 shown in FIG. 4A, in accordance with the operation by the user of the input device 120 with a Web browser, the mobile telephone 10 sends a URL over the mobile communication network 90 to the information server 30 to thereby access a Web site in the information server 30. The information server 30 at Step 302 receives the URL from the mobile telephone 10. At Step 304, the information server 30 sends a Web page associated with the received URL to the mobile telephone 10. As described above, the Web page may contain information about contents which the content server 50 can provide in respective time periods and the IDs (e.g. their titles and/or URLs) of the respective contents, and fees to be charged for downloading the contents. At Step 204, the mobile telephone 10 displays the received Web page on the display device 110.

Viewing the displayed Web page, the user may wish to take in particular content data related to some information contained in the Web page. In such a case, the user operates the input device 120 to highlight (e.g. reverse) the ID of that content in the Web page to choose it. A request picture for requesting the content data to be provided and transmitted is then displayed on the display device 110. The displayed picture contains the ID of the content to be provided. The user inputs an address of the desired receiver, e.g. an IP address of his or her home server 60, into a content data receiver address field on the displayed picture, and executes transmission of the request. The user may store the address in the mobile telephone 10 beforehand, which may be called out to input it in the receiver address field. At Step 206, the mobile telephone 10, in response to the execution of the transmission of the request, sends to the information server 30 the ID of the content (the title and/or URL of the content) and the receiver's address.

At Step 306, the information server 30 receives the content ID and the receiver's address from the mobile telephone 10. At Step 308, in accordance with the received content ID and receiver's address, the information server 30 sends the content server 50 a content data transmission request code including the content ID, the receiver's address and the user's ID, such as the telephone number and/or IP address of the mobile telephone 10.

At Step 508 (FIG. 4B), the content server 50 receives the content transmission request code containing the content ID, the receiver's address and the user ID from the information server 30. At Step 510, the content server 50 sends a content receiving request including the user ID to the home server 60.

At Step 612, the home server 60 receives the content receiving request including the user ID and checks the user ID. If it is determined that the received user ID is correct, the home server 60 sends the content server 50 an ACK or a content transmission permission, indicating that the homer server 60 is ready to receive the content. On the other hand, if it is determined that the user ID is incorrect, the home server 60 sends the content server 50 a NAK or content transmission rejection signal.

At Step 512, the content server 50 determines whether or not an ACK or content transmission permission has been received from the home server 60. When the content server 50 has not received the ACK for a predetermined time period or has received the NAK, it notifies the mobile telephone 10 of an error at Step 514. When receiving the error notification, the mobile telephone 10 indicates an error in the content transmission request on the display device 110 at Step 214.

When receiving the ACK at Step 512, the content server 50 transmits the requested content data to the home server 60 at Step 516. At Step 618, the home server 60 receives the content data and stores it in the memory device 604.

In the manner described above, the home server 60 can receive, store and manage different content data designated by the user in the mobile environment. The user can make use of the content data stored in the home server 60 on the home appliance 70. If the content data is a news video clip, he or she can reproduce it on a television apparatus (70). If the content data is music, it can be reproduced by means of an audio apparatus (70). The user can load one of pieces of the stored music into a record medium, for example, a Memory Stick™ of Sony Corp., an SD card, a compact flash, or a MMC, which can be inserted in the mobile telephone 10 for reproduction.

After sending the content data, the content server 50, at Step 518, sends the accounting server 40 a content transmission completion code including the user ID and the fee for making use of the content.

At Step 418 in FIG. 4C, the accounting server 40 receives the content transmission completion code from the content server 50, and, at Step 420, writes the content using fee in the user's account. At Step 422, the accounting server 40 notifies the mobile telephone 10 of the completion of the content data transmission together with the content using fee. At Step 222, the mobile telephone 10 receives the notification of the content data transmission completion together with the content using fee and displays them on the display device 110. The notification of the transmission completion and the fee may be sent to the mobile telephone by electronic mail, or the mobile telephone 10 may access through the Web browser.

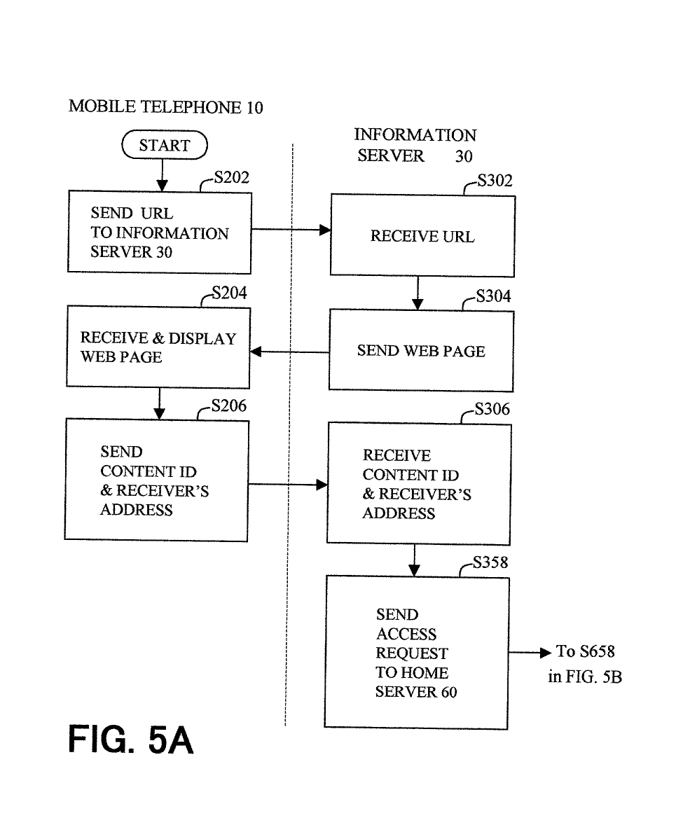

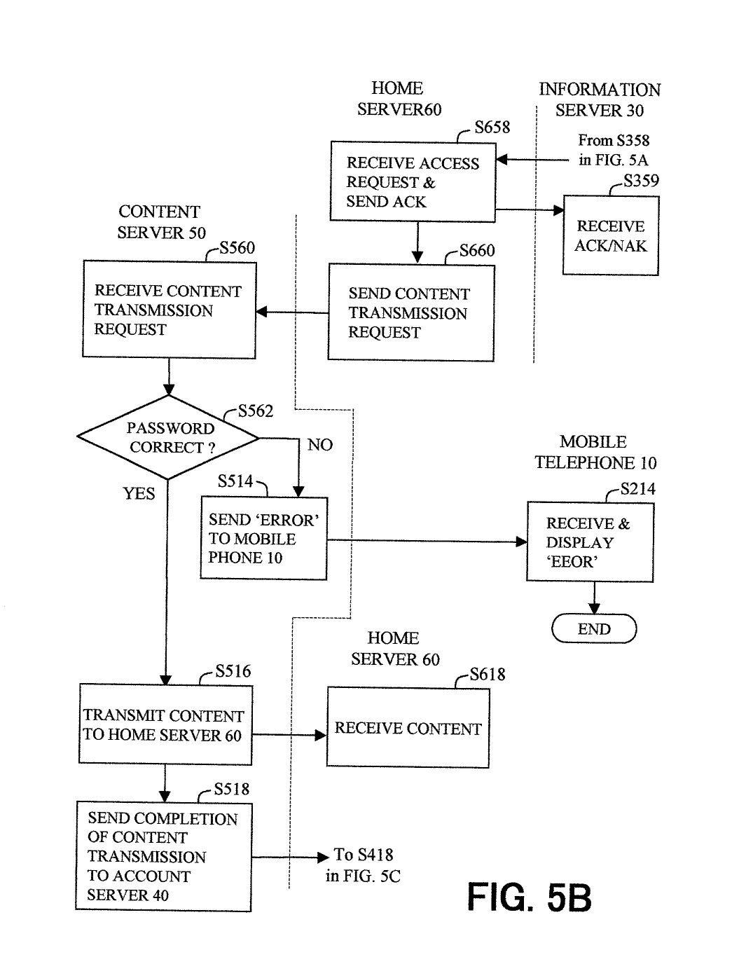

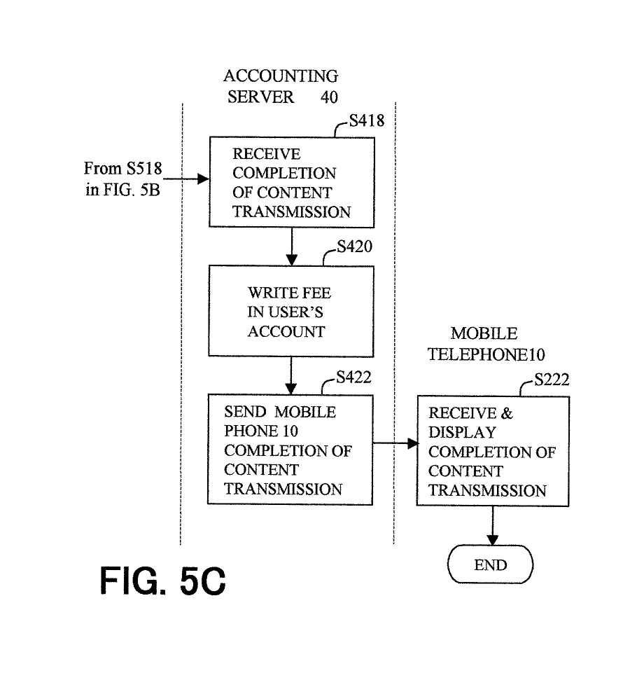

FIGS. 5A through 5C together show another exemplary flow chart of the steps executed by the mobile telephone 10, the information server 30, the accounting server 40, the content server 50 and the home server 60 over the mobile communication network 90, the network 96 and the gateway 94.

In FIG. 5A, Steps 202-206 and 302-306 are the same as Steps 202-206 and 302-306 shown in FIG. 4A, and hence are not described again.

At Step 358, the information server 30 sends the home server 60 an access request code including the content URL or both the content URL and ID, the user ID and a password for logging in the content server 50, in accordance with the content URL or both the content URL and ID and the address of a content receiver sent to the information server 30 from the mobile telephone 10.

At Step 658 shown in FIG. 5B, the home server 60 receives the access request code including the content URL or both the content URL and ID, the user ID and the password for logging in the content server 50, from the information server 30. Then, the home server 60 checks the user ID and, when the user ID is correct, sends an ACK to the information server 30. Then, at Step 660, the home server 60 sends the content server 50 a content transmission request code including the content URL or both the content URL and ID, the user ID and the password for logging in the content server 50. If the user ID is incorrect, the home server 60 sends a NAK to the information server 60.

The information server 30 receives the ACK/NAK from the home server 60 at Step 359.

The information server 30 notifies the mobile telephone 10 of an error when it has not received an ACK for a predetermined time or has received a NAK, as is done at Step 514 shown in FIG. 4B.

At Step 560, the content server 50 receives from the home server 60, the content transmission request code including the password and, at Step 562, checks the received password. If it is determined that the password is incorrect, the content server 50 notifies the mobile telephone 10 of the error at Step 514. When the mobile telephone 10 receives the error notification at Step 214, it displays the error in the request for access to the content on the display device 110.

If it is determined that the password is correct at Step 562, the content server 50 transmits the requested content data to the home server 60 at Step 516.

The remaining Steps 618 and 518 shown in FIG. 5B and Steps 148-422 and 222 shown in FIG. 5C are the same as the ones shown in FIGS. 4B and 4C and described above, and hence are not described again.

The embodiments described above and shown in the drawings are only typical examples of the invention. Variations and modifications of the embodiments are obvious to people skilled in the art within the scope of the invention defined by the accompanying claims.

What is claimed is:

1. A mobile device having a processor, a memory device, an input device and a display;
said processor transmitting to an information processing apparatus, over a mobile communication network, a content transmission request including a content identification of a content determined by a user and an address of a receiving device determined by said user which is to receive data of said content, said receiving device being different from said mobile device.

2. The mobile device according to claim 1 wherein said content identification is contained in a Web page received from said information processing apparatus over said mobile communication network and displayed on said display.

3. An information processing apparatus having a processor and a memory device;
said processor receiving a content transmission request including a content identification of a content determined by a user and an address of a receiving device determined by said user which is to receive data of said content, from a separate device different from said receiving device over a mobile communication network,
said processor transmitting, over a network, said received content identification and said received address of said receiving device to a content data providing information processing apparatus which provides said content data.

4. The information processing apparatus according to claim 3 wherein said processor transmits a Web page containing said content identification to said separate device over said mobile communication network.

5. The information processing apparatus according to claim 3 wherein said processor transmits further a user identification of the user to said content data providing information processing apparatus.

6. An information processing apparatus having a processor and a memory device;
said processor receiving a content transmission request including a content identification of a content determined by a user and an address of a receiving device determined by said user which is to receive data of said content, from a separate apparatus different from said receiving device over a network,
said processor transmitting content data associated with said content identification to said receiving device.

7. The information processing apparatus according to claim 6 wherein said processor receives further a user identification of the user from said separate apparatus and transmits said received user identification to said receiving device.

8. The information processing apparatus according to claim 6 wherein said processor sends the completion of transmission of the content data to said separate apparatus over said network.

9. An information processing apparatus having a processor and a memory device;
said processor receiving a content transmission request including a content identification of a content determined by a user and an address of a receiving device determined by said user which is to receive data of said content, from a separate device different from said receiving device over a mobile communication network,
said processor transmitting a content capturing request including the content identification to said receiving device over a network.

10. The information processing apparatus according to claim 9 wherein said processor transmits a Web page containing said content identification to said separate device over said mobile communication network.

11. The information processing apparatus according to claim 9 wherein said processor transmits further a user identification of the user and a password to said receiving device.

12. An information processing apparatus having a processor and a memory device;
said processor receiving a content capturing request including a content identification of a content determined by a user, from a separate apparatus over a network,
said processor using said content identification to access a content data providing information processing apparatus over said network and receiving content data associated with said content identification from said content providing information processing apparatus.

13. The information processing apparatus according to claim 12 wherein said processor receives further a user identification of the user and a password from said separate apparatus, and transmits said received password to said content data providing information processing apparatus.

14. A program stored on a recording medium for use in a mobile device having a processor, a memory device, an input device and a display;
said program being operable to cause said processor to execute the step of transmitting to an information processing apparatus, over a mobile communication network, a content transmission request including a content identification of a content determined by a user and an address of a receiving device determined by said user which is to receive data of said content, said receiving device being different from said mobile device.

15. The program according to claim 14 wherein said program is operable to cause said processor to execute the step of receiving a Web page containing said content identification from said information processing apparatus over said mobile communication network.

16. A program stored on a recording medium for use in an information processing apparatus, said program being operable to effect the steps of:
receiving a content transmission request including a content identification of a content determined by a user and an address of a receiving device determined by said user which is to receive data of said content, from a separate device different from said receiving device over a mobile communication network; and
transmitting, over a network, said received content identification and said received address of said receiving device to a content data providing information processing apparatus which provides said content data.

17. The program according to claim 16 wherein said program is operable to effect the step of transmitting a Web page containing said content identification to said separate device over said mobile communication network.

18. A program stored on a recording medium for use in an information processing device, said program being operable to effect the steps of:
receiving a content transmission request including a content identification of a content determined by a user and an address of a receiving device determined by said user which is to receive data of said content, from a separate apparatus different from said receiving device over a network; and
transmitting content data associated with said content identification to said receiving device.

19. The program according to claim 18 wherein said program is operable to effect the step of sending the completion of transmission of the content data to said separate apparatus over said network.

20. A program stored on a recording medium for use in an information processing device, said program being operable to effect the steps of:
receiving a content transmission request including a content identification of a content determined by a user and an address of a receiving device determined by said user which is to receive data of said content, from a separate device different from said receiving device over a mobile communication network; and
transmitting a content capturing request including the content identification to said receiving device over a network.

21. The program according to claim 20 wherein said program is operable to effect the step of transmitting a Web page containing said content identification to said separate device over said mobile communication network.

22. A program stored on a recording medium for use in an information processing apparatus, said program being operable to effect the steps of:
receiving a content capturing request including a content identification of a content determined by a user, from a separate apparatus over a network; and
using said content identification to access a content data providing information processing apparatus over said network and receiving content data associated with said content identification from said content providing information processing apparatus.

23. A content data distributing system including a first information processing apparatus connected to a first network having a mobile communication function, and a second information processing apparatus connected to a second network which, in turn, is connected to said first network;
said first information processing apparatus receiving, over said first network, a content transmission request including a content identification of a content determined by a user and an address of a third information processing apparatus determined by said user which is to receive data of said content, and transmitting said received content identification and third information processing apparatus address to said second information processing apparatus over said first and second networks;
said second information processing apparatus receiving said transmitted content identification and third information processing apparatus address and transmitting content data associated with said received content identification to said third information processing apparatus over said second network.

24. A content data distributing system including a first information processing apparatus connected to a first network having a mobile communication function, and a second information processing apparatus connected to a second network which, in turn, is connected to said first network;
said first information processing apparatus receiving, over said first network, a content transmission request including a content identification of a content determined by a user and an address of a third information processing apparatus determined by said user which is to receive data of said content, and transmitting said received content identification to said third information processing apparatus over said first and second networks;
said second information processing apparatus being responsive to said content identification received from said third information processing apparatus for transmitting content data associated with said content identification to said third information processing apparatus over said second network.
